(19) United States
(12) Patent Application Publication
(10) Pub. No.: US 2026/0327451 A1
(43) Pub. Date: Oct. 22, 2026

(54) THERMOPLASTIC RESIN COMPOSITION

(71) Applicant: TAICA CORPORATION, Tokyo (JP)

(72) Inventors: Hiroki Shibahara, Tokyo (JP); Yuichi Shiratori, Tokyo (JP)

(73) Assignee: TAICA CORPORATION, Tokyo (JP)

(21) Appl. No.: 19/113,130

(22) PCT Filed: Jul. 25, 2024
(86) PCT No.: PCT/JP2024/026551

§ 371 Date: Mar. 19, 2025

(30) Foreign Application Priority Data
Aug. 7, 2023 (WO) PCT/JP2023/028680

(51) Int. Cl. C09D 153/02; A43B 13/04; C09D 7/48; C09D 7/65

(52) U.S. Cl. CPC C09D 153/02; A43B 13/04; C09D 7/48; C09D 7/65

(57) ABSTRACT

Provided is a thermoplastic resin composition that can form a cushioning member having an excellent adhesive property, capable of being suppressed from peeling due to stress deformation, and also having weather resistance, without providing a coating layer on a surface of the cushioning member.

The thermoplastic resin composition comprises a thermoplastic styrenic elastomer (A) and a softener (B). The thermoplastic styrenic elastomer (A) includes one or more block copolymers, each composed of at least a styrene block and a butadiene block. In this thermoplastic styrenic elastomer (A), the total content of butadiene with carbon-carbon double bonds of the butadiene block is from 59.0 to 68.5 mass %, and the mixing ratio of the thermoplastic styrenic elastomer (A) and the softener (B), B/(A+B), is greater than 0.410 and less than 0.600 by mass ratio.

### TECHNICAL FIELD

The present invention relates to a thermoplastic resin composition that is applied to, for example, a cushioning member for shoes, such as a sole and an insole of shoes.

### BACKGROUND ART

When cushioning is applied to a portion visible from the outside, such as soles of footwear, smartphone protection cases, and grips and shoulder pads for bags, a cushioning member also having an excellent design is adopted. For example, in shoes designing in the field of requiring functionality, such as sport shoes, a cushioning member with an excellent cushioning property is incorporated in a sole member formed from a resin or the like. The cushioning member of this type is required to be lightweight from the viewpoint of ease of handling and not hindering the movements of a user and is also required to have high design quality, such as transparency in appearance, for being incorporated in a sole member in the form that can be visually recognized from the outside such that its functionality can be appealed to consumers. Therefore, various cushioning members made of thermoplastic styrenic elastomers having a low specific gravity (lightweight) and also transparency have been proposed.

For example, when such a cushioning member is applied to footwear, Japanese Patent No. 5966110 by the present applicant has proposed a cushioning member for footwear made of a thermoplastic styrenic elastomer and having excellent lightweight, transparent, flexible, and adhesive properties. This cushioning member for footwear is obtained by molding a cushioning composition for footwear that contains a thermoplastic styrenic elastomer composed of at least a styrene-ethylene-butylene-styrene block copolymer (SEBS), an amine-modified styrene-ethylene-butylene-styrene block copolymer (amine-modified SEBS), and a styrene-ethylene-ethylene-propylene-styrene block copolymer (SEEPS) and a softener in a predetermined mixing ratio, in which the molecular weight, the styrene content, and the mixing ratio of each block copolymer are adjusted within predetermined ranges.

In recent years, in order to further pursue functionality and design quality by a cushioning member, the shapes are becoming more diverse, such as an increase in the size of the cushioning member and an eye-catching design from the outside, by taking advantage of the lightweight property of the cushioning member. For example, in designing of high functional shoes, as shown in FIGS. 1 and 2(a), a cushioning member 10 is disposed and incorporated on the side of a sole member 20 so as to protrude therefrom.

In such a shoes design, in order to correspond to not only compressive deformation but also complicated stress deformation such as shear deformation, a more reliable adhesive property is required. Accordingly, in the cushioning member for footwear proposed in the above-described Japanese Patent No. 5966110, in order to improve the adhesive property with the sole member, a protective layer made of a urethane coating agent with an excellent adhesive property is formed on the outermost surface of the cushioning member.

### CITATION LIST

### Patent Literature

Patent Literature 1: Japanese Patent No. 5966110

### SUMMARY OF INVENTION

### Technical Problem

However, in order to dispose the above-described protective layer made of a urethane coating agent on the outermost surface of the cushioning member, it is necessary to perform a step of applying a primer agent to the surface of a molded product of a cushioning composition, a step of drying the primer agent to form a primer treatment layer, a step of applying a photocuring urethane coating agent on the primer treatment layer, a step of drying the urethane coating agent, and a step of subjecting the urethane coating agent to photocuring treatment to form a protective layer. Thus, a large number of steps is necessary, and therefore it takes time and effort.

For such problems in the adhesive property, in order to improve the adhesive property of the cushioning member itself without providing a coating layer of a urethane coating agent or the like on the cushioning member, it has been studied that a main component of the thermoplastic styrenic elastomer constituting the cushioning member is changed to a styrene-butadiene-styrene block copolymer (SBS) instead of a styrene-ethylene-butylene-styrene block copolymer (SEBS). However, since the reactivity of the carbon-carbon double bond included in the butadiene block constituting SBS is high, degradation easily occurs by heat, light, ozone, or the like, and there are problems in weather resistance, such that fine cracks occur and cause cloudiness on the surface of the cushioning member or oil bleeding happens on the resin surface.

The present invention has been made in view of the above points, and it is an object to provide a thermoplastic resin composition that can form a cushioning member having an excellent adhesive property, capable of being suppressed from peeling due to stress deformation, and also having weather resistance, without providing a coating layer that contributes to improvement in the adhesive property of the surface of the cushioning member.

### Solution to Problem

The present inventors found that when a main component of the thermoplastic styrenic elastomer is a block copolymer composed of a styrene block and a butadiene block having carbon-carbon double bonds, a cushioning member that can simultaneously achieve improvement in the adhesive property to suppress peeling due to stress deformation and improvement in the weather resistance is obtained by adjusting the amount of the carbon-carbon double bonds included in the butadiene block within a specific range. Based on this knowledge, the present invention was accomplished.

In order to solve the above-mentioned problems, the thermoplastic resin composition of the present invention is a thermoplastic resin composition containing a thermoplastic styrenic elastomer (A) and a softener (B), wherein the thermoplastic styrenic elastomer (A) includes one or more block copolymers, each composed of at least a styrene block and a butadiene block, and in this thermoplastic styrenic elastomer (A), the total content of butadiene with carbon-carbon double bonds of the butadiene block is from 59.0 to 68.5 mass %, and the mixing ratio of the thermoplastic styrenic elastomer (A) and the softener (B), B/(A+B), is greater than 0.410 and less than 0.600 by mass ratio.

The thermoplastic resin composition of the present invention includes a thermoplastic styrenic elastomer (A) and a softener (B), and this thermoplastic styrenic elastomer (A) includes one or more block copolymers, each composed of at least a styrene block and a butadiene block. In this thermoplastic styrenic elastomer (A), the total content of butadiene with the carbon-carbon double bonds of the butadiene block is adjusted to from 59.0 to 68.5 mass %, and the mixing ratio of the thermoplastic styrenic elastomer (A) and the softener (B), B/(A+B), is adjusted to greater than 0.410 and less than 0.600 by mass ratio, and thereby the resulting thermoplastic resin composition can form a cushioning member that has an excellent adhesive property, is suppressed from peeling by stress deformation, and also has excellent weather resistance. Therefore, when a cushioning member is formed from this thermoplastic resin composition, since the cushioning member can be bonded to an adherend member without providing a coating layer of a urethane coating agent or the like, it is possible to reduce the labor and manufacturing costs associated with preparation of the cushioning member and its incorporation. The weather resistance in the present invention means that degradation due to ozone, light, heat (including wet heat) hardly occurs.

In the thermoplastic resin composition of the present invention, the total content of the styrene block in the thermoplastic styrenic elastomer (A) is also preferably from 31.5 to 41.0 mass %. Consequently, a suitable styrene block content in the thermoplastic styrenic elastomer (A) of the present invention is selected. Consequently, a thermoplastic resin composition that can form a cushioning member having an excellent adhesive property with another member, capable of simultaneously achieving suppression of peeling due to stress deformation and improvement in the weather resistance, and also having excellent transparency in appearance and an excellent cushioning property is obtained.

In the thermoplastic resin composition of the present invention, a main component of the thermoplastic styrenic elastomer (A) is also preferably a styrene-butadiene-styrene triblock copolymer (A1). Consequently, as a structural component of the thermoplastic styrenic elastomer (A) of the present invention, a suitable component is selected. The resulting thermoplastic resin composition by selecting the styrene-butadiene-styrene triblock copolymer (A1) can form a cushioning member having an excellent adhesive property and an excellent effect of suppressing peeling due to stress deformation.

In the thermoplastic resin composition of the present invention, it is also preferable that the thermoplastic styrenic elastomer (A) include a styrene-butadiene-styrene triblock copolymer (A1) and a styrene-butadiene diblock copolymer (A2) and that the mixing ratio of the styrene-butadiene-styrene triblock copolymer (A1) and the styrene-butadiene diblock copolymer (A2), (A1):(A2), be 1:greater than 0 and less than 0.3 by mass ratio. The total content of butadiene with carbon-carbon double bonds of the butadiene block in the thermoplastic styrenic elastomer (A) can be easily adjusted within a specific range, and the melt flowability of the thermoplastic resin composition of the present invention can be adjusted within a range allowing ease of handling, by constituting the thermoplastic styrenic elastomer (A) by the styrene-butadiene-styrene triblock copolymer (A1) and the styrene-butadiene diblock copolymer (A2).

The above-described styrene-butadiene-styrene triblock copolymer (A1) constituting the thermoplastic styrenic elastomer (A) preferably also includes a combination of an unhydrogenated styrene-butadiene-styrene triblock copolymer and a partially hydrogenated styrene-butadiene-styrene triblock copolymer. The total content of butadiene with carbon-carbon double bonds of the butadiene block in the thermoplastic styrenic elastomer (A) can be easily adjusted within a specific range, and a suitable block copolymer constituting the thermoplastic styrenic elastomer (A) of the present invention is selected, by using a combination of unhydrogenated product and partially hydrogenated product of a styrene-butadiene-styrene triblock copolymer.

In the thermoplastic resin composition of the present invention, it is also preferable that the butadiene block in one or more block copolymers be not substantially hydrogenated. Consequently, the total content of the butadiene block in the thermoplastic styrenic elastomer (A) and the total content of butadiene with carbon-carbon double bonds of the butadiene block are the same. Accordingly, since the total content of the styrene block can be easily adjusted within a suitable range while controlling the amount of the carbon-carbon double bonds included in the butadiene block within a specific range, a suitable block copolymer constituting the thermoplastic styrenic elastomer (A) of the present invention is selected. In addition, the thermoplastic resin composition according to the present invention has sufficient weather resistance, even if the butadiene block is not hydrogenated, by adjusting the amount of the carbon-carbon double bonds included in the butadiene block within a specific range.

In the thermoplastic resin composition of the present invention, the softener (B) is also preferably a paraffinic oil or naphthenic oil having a molecular weight of 300 to 1,200. Consequently, a thermoplastic resin composition that can form a cushioning member with excellent flexibility is obtained.

The thermoplastic resin composition of the present invention preferably further contains an antioxidant. Consequently, a thermoplastic resin composition forming a cushioning member with further improved weather resistance such as wet heat resistance is obtained.

The thermoplastic resin composition of the present invention preferably further contains a photostabilizer. Consequently, a thermoplastic resin composition forming a cushioning member with further improved weather resistance such as light resistance is obtained.

The hardness of a molded product of the thermoplastic resin composition of the present invention is from 30 to 50 Asker C (SRIS 0101 standard, 23±2° C.), and the haze value (conforming to JIS K7136: 2000) is also preferably 15% or less. The molded product of the thermoplastic resin composition having such physical properties has excellent flexibility and transparency and therefore can be suitably used as a cushioning member that is applied to a portion visible from the outside.

The cushioning member of the present invention is made of the above-described molded product of the thermoplastic resin composition. The cushioning member of the present invention is preferably also for footwear. Such a thermoplastic resin composition has excellent light resistance and design quality and is suitably used as a cushioning member for footwear.

The thermoplastic resin composition of the present invention is preferably also a composition for three-dimensional (3D) printing. The thermoplastic resin composition of the present invention is suitably used as a composition for 3D printing with an adhesive property and transparency. Accordingly, a cushioning member made of the molded product of the thermoplastic resin composition of the present invention can be formed by molding with a 3D printer.

### Advantageous Effects of Invention

According to the present invention, it is possible to provide a thermoplastic resin composition and a cushioning member having excellent effects as follows:
(1) A thermoplastic resin composition that can form a cushioning member having an excellent adhesive property, suppressed from peeling due to stress deformation, and also having weather resistance; and
(2) Since adhesion with sufficient strength is possible without providing a coating layer that contributes to improvement of adhesion to the surface of a cushioning member, the coating process after formation of the cushioning member is not necessary, the working time for manufacturing can be shortened, and the manufacturing cost can also be decreased. Since a coating layer is not provided, the thermoplastic resin composition can be easily recycled and the sustainability is improved.

### BRIEF DESCRIPTION OF DRAWINGS

FIG. 1 is a diagram schematically showing a sport shoe in which a cushioning member is incorporated in the side of the sole member.

FIG. 2(a) is a local sectional view schematically showing the configuration of a conventional cushioning member and sole portion, and FIG. 2(b) is a diagram showing the state when a load is applied.

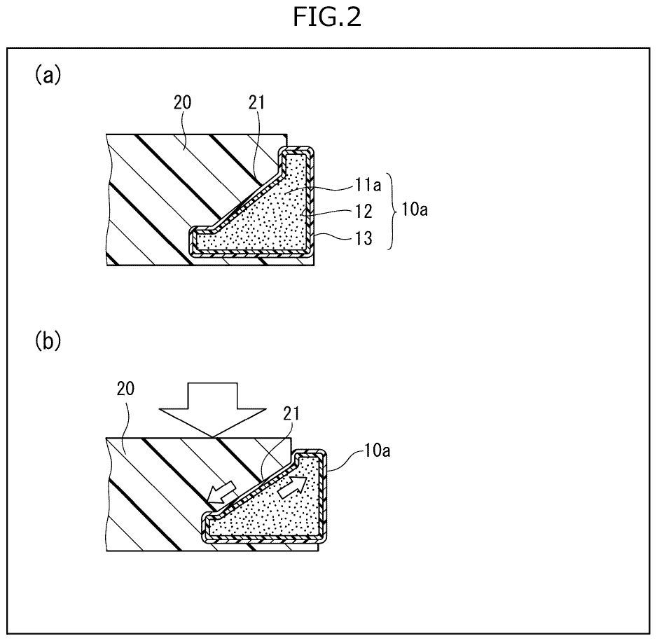

FIG. 3(a) and FIG. 3(b) are a plan view and a front view, respectively, schematically showing the configuration of a sample piece produced for a creep test and a peel strength measurement test in Examples and Comparative Examples.

FIG. 4 is a diagram for explaining a method of the creep test performed using the sample piece of FIG. 3.

FIG. 5 is a diagram for explaining a method of the peel strength measurement test performed using the sample piece of FIG. 3.

FIG. 6 is a diagram for explaining a method of an ozone exposure test for evaluating ozone resistance.

### DESCRIPTION OF EMBODIMENTS

The thermoplastic resin composition according to the present invention contains a thermoplastic styrenic elastomer (A) and a softener (B). This thermoplastic styrenic elastomer (A) includes one or more block copolymers, each composed of at least a styrene block and a butadiene block. The total content of butadiene with carbon-carbon double bonds of the butadiene block in the thermoplastic styrenic elastomer (A) is from 59.0 to 68.5 mass %. The mixing ratio of the thermoplastic styrenic elastomer (A) and the softener (B), B/(A+B), is greater than 0.410 and less than 0.600 by mass ratio.

Firstly, the thermoplastic styrenic elastomer (A) constituting the thermoplastic resin composition will be described. The thermoplastic styrenic elastomer (A) according to the present invention contains one or more block copolymers, each composed of at least a styrene block and a butadiene block. Examples of the block copolymer composed of at least a styrene block and a butadiene block include a styrene-butadiene diblock copolymer (hereinafter, also referred to as SB), a styrene-butadiene-styrene triblock copolymer (hereinafter, also referred to as SBS), and a styrene-butadiene-styrene-butadiene tetrablock copolymer. Among them, from the viewpoint of the effects according to the present invention, as the thermoplastic styrenic elastomer (A), a styrene-butadiene-styrene triblock copolymer (SBS), a styrene-butadiene diblock copolymer (SB), and a combination thereof can be suitably used. The styrene-butadiene-styrene triblock copolymer that can be used in the present invention may be a single compound or may be composed of multiple compounds. Similarly, the styrene-butadiene diblock copolymer also may be a single compound or may be composed of multiple compounds. As a main component of the thermoplastic styrenic elastomer (A), the styrene-butadiene-styrene triblock copolymer (SBS) is preferably used. In the present specification, the main component means the component or component group with the highest amount among the components or component groups constituting the thermoplastic styrenic elastomer (A). The block copolymer that is used in the present invention maintains carbon-carbon double bonds of the butadiene block and, therefore preferably, is not substantially hydrogenated, and if the total content of butadiene with carbon-carbon double bonds of the butadiene block can be adjusted within a predetermined range described later, the block copolymer may be partially hydrogenated. Specifically, examples of the partially hydrogenated block copolymer include a styrene-(butadiene-butylene)-styrene triblock copolymer (SBBS), which is a partially hydrogenated product of a styrene-butadiene-styrene triblock copolymer (SBS). When the styrene-butadiene-styrene triblock copolymer (SBS) is used as the main component of the thermoplastic styrenic elastomer (A) according to the present invention, a combination of an unhydrogenated SBS, which is not substantially hydrogenated, and a partially hydrogenated SBS (i.e., SBBS) may be used.

In the present invention, it is important to adjust the total content of butadiene with carbon-carbon double bonds of the butadiene block in the block copolymer constituting the thermoplastic styrenic elastomer (A) within a range from 59.0 to 68.5 mass %. That is, the carbon-carbon double bond of the butadiene block is highly reactive and therefore becomes a cause of degradation through reaction with ozone, light, or heat. However, because of the high reactivity, the adhesive property is improved, and peeling due to stress deformation is also suppressed. In the present invention, a thermoplastic resin composition that forms a cushioning member having an excellent adhesive property, capable of being suppressed from peeling due to stress deformation, and further having excellent weather resistance to withstand ozone, light, heat, and the like is obtained by adjusting the total content of butadiene with carbon-carbon double bonds of the butadiene block within a range from 59.0 to 68.5 mass %. In the present specification, the content of butadiene with carbon-carbon double bonds of the butadiene block is the content of the butadiene block when the block copolymer is not substantially hydrogenated, and can be determined by multiplying the content of the butadiene block by the percentage of unhydrogenated quantity when the block copolymer is partially hydrogenated.

In the present invention, the total content of butadiene with carbon-carbon double bonds of the butadiene block in the block copolymer constituting the thermoplastic styrenic elastomer (A) is, from the viewpoint of improvement in the adhesive property, suppression of peeling due to stress deformation, and improvement in the weather resistance, preferably within a range from 59.0 to 68.5 mass %, more preferably within a range from 62.0 to 68.0 mass %, and further preferably within a range from 64.0 to 66.0 mass %. Here, the total content of butadiene with carbon-carbon double bonds of the butadiene block is a value determined by a 1H-NMR method (absolute method) in accordance with JIS K 6239-1:2017 Styrene-butadiene rubber (SBR)—Determination of the microstructure of solution-polymerized SBR—Part 1: 1H-NMR and IR with Cast-film method.

On the other hand, the total content of the styrene block in the block copolymer constituting the thermoplastic styrenic elastomer (A) is preferably within a range from 31.5 to 41.0 mass %, more preferably within a range from 32.0 to 38.0 mass %, and further preferably within a range from 34.0 to 36.0 mass %. Consequently, a thermoplastic resin composition that can form a cushioning member having an excellent adhesive property with another member, capable of simultaneously achieving suppression of peeling due to stress deformation and improvement in weather resistance, and also having excellent transparency in appearance and an excellent cushioning property is obtained. Here, the total content of the styrene block is a value determined by a 1H-NMR method (absolute method) in accordance with JIS K 6239-1:2017 Styrene-butadiene rubber (SBR)—Determination of the microstructure of solution-polymerized SBR—Part 1: 1H-NMR and IR with Cast-film method.

As an embodiment according to the present invention, the total content of butadiene with carbon-carbon double bonds of the butadiene block is easily adjusted within a specific range by constituting the thermoplastic styrenic elastomer (A) by combining a styrene-butadiene-styrene triblock copolymer (A1) and a styrene-butadiene diblock copolymer (A2). In addition, the melt flowability of the thermoplastic resin composition of the present invention can also be adjusted within a range allowing ease of handling. The styrene-butadiene-styrene triblock copolymer (A1) includes, in addition to an (unhydrogenated) styrene-butadiene-styrene triblock copolymer, which is not substantially hydrogenated, a combination of an unhydrogenated styrene-butadiene-styrene triblock copolymer and a partially hydrogenated styrene-butadiene-styrene triblock copolymer (i.e., SBBS). The mixing ratio of the styrene-butadiene-styrene triblock copolymer (A1) and the styrene-butadiene diblock copolymer (A2), (A1):(A2), is preferably 1:greater than 0 and less than 0.3 by mass ratio, more preferably 1:0.03 or more and 0.2 or less, from the viewpoint of the effects of the present invention.

The molecular weight of the block copolymer constituting the thermoplastic styrenic elastomer (A) is not particularly limited. As an example, the average molecular weight of the block copolymer may be from 100,000 to 400,000, but preferably 104,000 or more from the viewpoint of mechanical strength and preferably 360,000 or less from the viewpoint of adhesive property and flowability during molding. That is, the average molecular weight of the block copolymer is preferably from 105,000 to 350,000. When the average molecular weight of the block copolymer is controlled within this range, an excellent adhesive property is obtained, a molded product that hardly causes peeling due to stress deformation such as flow deformation can be formed, and good flowability is obtained even during molding. The molecular weight in the present invention is a weight-average molecular weight Mw and is a value measured by gel permeation chromatography (GPC).

The block copolymer constituting the thermoplastic styrenic elastomer (A) in the present invention is not particularly limited, and as examples thereof, KRATON (registered trade mark) D1155, DX408, or DX405 (SBS, all products are manufactured by Kraton Polymers Japan Ltd.) and KRATON (registered trade mark) D1101, D1118, or DX423 (mixtures of SBS and SB, all products are manufactured by Kraton Polymers Japan Ltd.) can be used.

The block copolymer constituting the thermoplastic styrenic elastomer (A) in the present invention is prepared such that the total content of butadiene with carbon-carbon double bonds of the butadiene block is within a predetermined range, and can include, within this range, another styrenic block copolymer, in addition to the styrene-butadiene-styrene triblock copolymer (A1) and the styrene-butadiene diblock copolymer (A2). The additional styrenic block copolymer is not particularly limited, and examples thereof include a styrene-(ethylene-butylene)-styrene triblock copolymer (SEBS), a styrene-isoprene-styrene triblock copolymer (SIS), a styrene-(ethylene-propylene)-styrene triblock copolymer (SEPS), a styrene-isobutylene-styrene triblock copolymer (SIBS), a styrene-[ethylene-(ethylene-propylene)]-styrene block copolymer (SEEPS), a styrene-(ethylene-propylene) diblock copolymer (SEP), and the like.

Secondly, the softener (B) constituting the thermoplastic resin composition will be described. The softener (B) is added to the composition mainly for the purpose of providing flexibility. Regarding the mixing ratio of the softener (B), from the viewpoint of enhancing the flexibility and exhibiting the effects of the present invention, the mixing ratio of the softener (B) to the sum of the thermoplastic styrenic elastomer (A) and the softener (B) is preferably greater than 0.410 and less than 0.600, more preferably 0.416 or more and 0.550 or less, and particularly preferably 0.420 or more and 0.500 or less, by mass ratio. When the mixing ratio of the softener (B) is adjusted within the above-mentioned range, the thermoplastic resin composition can form a cushioning member having an excellent adhesive property, also suppressed from peeling due to stress deformation, and further having excellent weather resistance, while providing flexibility to the thermoplastic styrenic elastomer (A).

As the softener in the present invention, for example, a process oil such as paraffinic oil, naphthenic oil, or aromatic oil, a synthetic resin softener such as liquid polybutene or low molecular weight polybutadiene, or rosin is used. Among them, from the viewpoint of transparency in appearance, process oil, in particular, paraffinic oil is suitably used, and from the viewpoint of excellent adhesive property and mechanical strength, paraffinic oil or naphthenic oil having a weight-average molecular weight of 300 to 1,200 is particularly suitably used. As the softener, a single softener may be used, or a combination of multiple softeners having different components and physical properties such as viscosity (molecular weight) may be used.

The thermoplastic resin composition in the present invention may further contain an antioxidant, from the viewpoint of further improving the weather resistance. The thermoplastic resin composition and its molded product (cushioning member) are prevented from oxidation by containing the antioxidant and thereby can be provided with a function of more improving the weather resistance. Examples of the antioxidant include hindered amine antioxidant and hindered phenolic antioxidant functioning as a chain stopping agent, phosphite antioxidant and thioether antioxidant functioning as a peroxide decomposition agent, and the like. As the hindered amine antioxidant, a known antioxidant can be appropriately selected, and thereof include examples N,N′,N″,N′″-tetrakis-(4,6-bis(butyl-(N-methyl-2,2,6,6-tetramethylpiperidin-4-yl)amino)-triazin-2-yl)-4,7-diazadecane-1,10-diamine, a dibutylamine/1,3,5-triazine/N,N′-bis-(2,2,6,6-tetramethyl-4-piperidyl-1,6-hexamethylenediamine/N-(2,2,6,6-tetramethyl-4-piperidyl)butylamine polycondensate, poly[{6-(1,1,3,3-tetramethylbutyl)amino-1,3,5-triazine-2,4-diyl}{(2,2,6,6-tetramethyl-4-piperidyl)imino}hexamethylene{(2,2,6,6-tetramethyl-4-piperidyl)imino}], a polymer of dimethyl succinate and 4-hydroxy-2,2,6,6-tetramethyl-1-piperidineethanol, [decanedioic acid bis(2,2,6,6-tetramethyl-1(octyloxy)-4-piperidyl) ester, a reaction product of 1,1-dimethylethylhydroperoxide and octane (70%)]-polypropylene (30%), bis(1,2,2,6,6-pentamethyl-4-piperidyl) [[3,5-bis(1,1-dimethylethyl)-4-hydroxyphenyl]methyl]butyl malonate, methyl 1,2,2,6,6-pentamethyl-4-piperidyl sebacate, bis(2,2,6,6-tetramethyl-4-piperidyl) sebacate, bis(1,2,2,6,6-pentamethyl-4-piperidyl) sebacate, 1-[2-[3-(3,5-di-tert-butyl-4-hydroxyphenyl) propionyloxy]ethyl]-4-[3-(3,5-di-tert-butyl-4-hydr oxyphenyl) propionyloxy]-2,2,6,6-tetramethylpiperidine, 4-benzoyloxy-2,2,6,6-tetramethylpiperidine, 8-acetyl-3-dodecyl-7,7,9,9-tetramethyl-1,3,8-triazaspiro[4.5]decane-2,4-dion, and the like.

As the hindered phenolic antioxidant, a known antioxidant can be appropriately selected, and examples thereof include pentaerythritol tetrakis[3-(3,5-di-tert-butyl-4-hydroxyphenyl) propionate], octadecyl-3-(3,5-di-tert-butyl-4-hydroxyphenyl) propionate, thiodiethylene bis[3-(3,5-di-tert-butyl-4-hydroxyphenyl) propionate], N,N′-hexane-1,6-diylbis[3-(3,5-di-tert-butyl-4-hydroxyphenyl propionamide), 2,4-dimethyl-6-(1-methylpentadecyl) phenol, diethyl[[3,5-bis(1,1-dimethylethyl)-4-hydroxyphenyl]methyl]phosphate, 3,3′,3″,5,5′,5″-hexa-tert-butyl-a,a′,a″-(mesitylene-2,4,6-triyl)tri-p-cresol, 4,6-bis(octylthiomethyl)-o-cresol, ethylene bis(oxyethylene) bis[3-(5-tert-butyl-4-hydroxy-m-triyl) propionate], bis[3-(3,5-di-tert-butyl-4-hydroxyphenyl) propionate], hexamethylene 1,3,5-tris(3,5-di-tert-butyl-4-hydroxybenzyl)-1,3,5-triazine-2,4,6 (1H,3H,5H)-trione, 2,6-di-tert-butyl-4-(4,6-bis(octylthio)-1,3,5-triazin-2-ylamino) phenol, 2-[1-(2-hydroxy-3,5-di-t-phenylpentyl)ethyl]-4,6-di-t-phenylpentyl acrylate, and the like.

As the phosphite antioxidant, a known antioxidant can be appropriately selected, and examples thereof include triphenyl phosphite, tris(nonylphenyl) phosphite, dilauryl hydrogen phosphite, triethyl phosphite, tridecyl phosphite, tris(2-ethylhexyl) phosphite, tris(tridecyl) phosphite, tristeary phosphite, diphenyl monodecyl phosphite, monophenyl didecyl phosphite, diphenyl mono(tridecyl) phosphite, tetraphenyl dipropylene glycol diphosphite, tetraphenyl tetra(tridecyl) pentaerythritol tetraphosphite, hydrogenated bisphenol A phenol phosphite polymer, diphenyl hydrogen phosphite, 4,4′-butylidene-bis(3-methyl-6-tert-butylphenyl di(tridecyl) phosphite tetra(tridecyl)-4,4′-isopropylidene diphenyl diphosphite, bis(tridecyl) pentaerythritol diphosphite, bis(nonylphenyl) pentaerythritol diphosphite, dilauryl pentaerythritol diphosphite, distearyl pentaerythritol diphosphite, tris(4-tert-butylphenyl) phosphite, tris(2,4-di-tert-butylphenyl) phosphite, hydrogenated bisphenol A pentaerythritol phosphite polymer, bis(2,4-di-tert-butylphenyl) pentaerythritol diphosphite, bis(2,6-di-tert-butyl-4-methylphenyl) pentaerythritol diphosphite, 2,2′-methylene bis(4,6-di-tert-butylphenyl) octyl phosphite, bis(2,4-dicumylphenyl) pentaerythritol diphosphite, and the like.

As the thioether antioxidant, a known antioxidant can be appropriately selected, and examples thereof include pentaerythritol tetrakis(3-dodecylthiopropionate), didodecyl thiodipropionate, ditridecyl thiodipropionate, ditetradecyl thiopropionate, dioctadecyl thiodipropionate, 2-mercaptobenzimidazole, 2,4-bis[(dodecylthio)methyl]-6-methylphenol, and the like.

As the antioxidant, the above-mentioned examples can be used alone or in combination of two or more. When two or more oxidants are combined, the combination may be of the same component system or of different component systems. The combination of different components is preferably a hindered phenolic antioxidant, a phosphite antioxidant, and a thioether antioxidant. More specifically, the combination is more preferably of 2,2′-methylene bis(4,6-di-tert-butylphenyl)octyl phosphite as the phosphite antioxidant, 2-[1-(2-hydroxy-3,5-di-t-phenylpentyl)ethyl]-4,6-di-t-phenylpentyl acrylate as the hindered phenolic antioxidant, and 2,4-bis[(dodecylthio)methyl]-6-methylphenol as the thioether antioxidant. The addition rate of the antioxidant is preferably 0.1 to 2 parts by mass, more preferably 0.5 to 1.5 parts by mass, based on 100 parts by mass of the thermoplastic styrenic elastomer (A). When multiple antioxidants are combined, the total addition rate of the antioxidants is preferably within the above-mentioned range, and the addition rate of each antioxidant is set within the range.

The thermoplastic resin composition in the present invention may contain a photostabilizer from the viewpoint of further improving the weather resistance. The thermoplastic resin composition and its molded product (cushioning member) are prevented from photooxidation degradation by containing the photostabilizer, and can be provided with a function of more improving the weather resistance. Examples of the photostabilizer include a hindered amine photostabilizer (HALS) having a function of scavenging and detoxifying radicals generated by photodegradation and a benzotriazole ultraviolet absorber absorbing ultraviolet rays to suppress a photoinduced reaction that leads to photodegradation of polymers and thereby functioning as a light resistance stabilizer. These photostabilizers can be used alone or in combination of two or more. A tertiary amine-containing hindered amine photostabilizer is preferably used as the hindered amine photostabilizer for improving the storage stability of the composition. Examples of the tertiary amine-containing hindered amine photostabilizer include Tinuvin 622LD, Tinuvin 144, Tinuvin 765, and Chimassorb 119 FL (these products are all manufactured by BASF); MARK series LA-57, LA-62, LA-67, and LA-63 (these products are all manufactured by Adeka Corporation); SANOL series LS-765, LS-292, LS-2626, LS-1114, and LS-744 (these products are all manufactured by Sankyo Co., Ltd.); and the like. Examples of the ultraviolet absorber include benzotriazole, triazine, benzophenone, and benzoate compounds, and the like. As the ultraviolet absorber, a known ultraviolet absorber can be appropriately selected, and examples thereof include a benzotriazole ultraviolet absorber such as 2,4-di-tert-butyl-6-(5-chlorobenzotriazol-2-yl) phenol, 2-(2H-benzotriazol-2-yl)-4,6-di-tert-pentylphenol, 2-(2H-benzotriazol-2-yl)-4-(1,1,3,3-tetramethylbutyl) phenol, a reaction product of methyl 3-(3-(2H-benzotriazol-2-yl)-5-tert-butyl-4-hydroxyphenyl) propionate and polyethylene glycol 300, and 2-(2H-benzotriazol-2-yl)-6-(linear and side chain dodecyl)-4-methylphenol; a triazine ultraviolet absorber such as 2-(4,6-diphenyl-1,3,5-triazin-2-yl)-5-[(hexyl)oxy]-phenol; a benzophenone ultraviolet absorber such as octabenzone; a benzoate ultraviolet absorber also having a radical scavenging function such as 2,4-di-tert-butylphenyl-3,5-di-tert-butyl-4-hydroxybenzoate; and the like. The above-mentioned hindered amine photostabilizers and ultraviolet absorbers may be used alone or in combination of two or more. When the hindered amine photostabilizer and the ultraviolet absorber are used in combination, a combination of a hindered amine photostabilizer and a benzophenone ultraviolet absorber is preferable. The addition rate of the photostabilizer is preferably from 0.1 to 1.0 parts by mass, more preferably from 0.3 to 0.7 parts by mass, based on 100 parts by mass of the thermoplastic styrenic elastomer (A). When a combination of the hindered amine photostabilizer and the ultraviolet absorber is used, they may be combined in an appropriate rate within the above range.

Furthermore, as an embodiment of the present invention, the thermoplastic resin composition can contain another additive within the range that does not impair the effects of the present invention. Examples of the additive include a pigment, a coloring agent, a filler, a lubricant, and a mold-releasing agent. These additives can be used alone or in combination of two or more.

The thermoplastic resin composition of the present invention is required to have flexibility for sufficiently exhibiting cushioning. Specifically, the hardness of the molded product is preferably from 15 to 70 Asker C (SRIS 0101 standard, 23±2° C.), more preferably from 25 to 60 Asker C, and particularly preferably from 30 to 50 Asker C. Consequently, a thermoplastic resin composition that forms a cushioning member having sufficient flexibility contributing to the cushioning property and an excellent adhesive property, hardly causing peeling due to stress deformation such as flow deformation, and also having weather resistance is obtained.

The thermoplastic resin composition of the present invention is required to have transparency from the viewpoint of enhancing the design in appearance. Specifically, the haze value (conforming to JIS K7136: 2000) is preferably 40% or less, more preferably 30% or less, and particularly preferably 15% or less. Consequently, a thermoplastic resin composition that forms a cushioning member having high transparency in appearance and an excellent adhesive property, hardly causing peeling due to stress deformation such as flow deformation, and also having weather resistance is obtained.

The thermoplastic resin composition of the present embodiment is manufactured by a known method for manufacturing a resin composition. Specifically, as an example, the thermoplastic resin composition is obtained by uniformly kneading components such as a thermoplastic styrenic elastomer (A) and a softener (B) or components such as a thermoplastic styrenic elastomer (A), a softener (B), an antioxidant, and/or a photostabilizer, and other various components to be added as needed in a predetermined proportion, each component being heated into a melted state, using a melt kneader such as a single screw extruder, a twin screw extruder, a kneader, a Banbury mixer, or a heating roller. In order to enhance the dispersibility of the thermoplastic styrenic elastomer (A) and the softener (B), the melt-kneading may be performed after absorbing at least a part of the softener (B) in the thermoplastic styrenic elastomer (A) in advance.

The thermoplastic resin composition obtained as described above is subjected to pellet or filament formation as needed and is then formed into a predetermined shape by a known method such as injection molding, extrusion molding, blow molding, compression molding, calendar molding, or 3D molding with a 3D printer to obtain a molded product of the thermoplastic resin composition according to the present invention. The haze value (conforming to JIS K7136: 2000) of the molded product of the thermoplastic resin composition of the present embodiment is particularly preferably 15% or less. The hardness is particularly preferably from 30 to 50 Asker C (SRIS 0101 standard). Accordingly, the molded product made of the thermoplastic resin composition can be suitably used as a cushioning member having high transparency in appearance and sufficient flexibility contributing to a cushioning property.

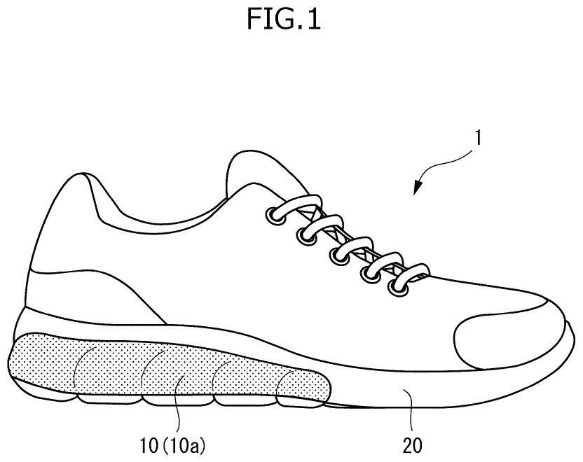

The cushioning member made of the molded product of the thermoplastic resin composition of the present invention will be described. The cushioning member of an embodiment of the present invention can be suitably used as a cushioning member 10 for footwear such as sport shoes, as shown in FIG. 1. The cushioning member 10 for footwear of the present embodiment can be easily bonded to a sole member 20 such as an EVA resin (ethylene-vinyl acetate copolymer resin) forming the sole of a shoe 1 with an adhesive directly or via a primer treatment layer, and there is no need to provide a coating layer made of a urethane coating agent or the like in the bonding. That is, the cushioning member 10 for footwear itself has a high adhesive property and can be therefore strongly bonded to the sole member 20 by a known adhesive, and peeling by flow deformation (creep) also hardly occurs. Therefore, according to the cushioning member 10 for footwear of the present invention, the manufacturing cost for footwear can be decreased, and strong footwear can be obtained. The cushioning member 10 for footwear has weather resistance hardly causing degradation due to light, ozone, heat, or the like and also has excellent transparency (design quality) and an excellent cushioning property as described above.

The cushioning member made of the molded product of the thermoplastic resin composition of the present invention is bonded to an adherend member depending on the intended use via an adhesive. As the adhesive, a known adhesive compatible with a styrene elastomer can be appropriately selected depending on the material of the adherend member. For example, in application to footwear, an adhesive for shoemaking such as a polyurethane adhesive and an adhesive for chloroprene rubber can be used. In order to enhance the adhesiveness of the cushioning member with an adherend member such as a sole member and to ensure higher adhesion reliability, the cushioning member and the adherend member are preferably bonded via a primer treatment layer. Here, the primer treatment layer refers to a layer formed by treating the surface of the adherend member or the molded product (cushioning member) of the thermoplastic resin composition with a primer agent such as a surface treatment agent in advance. Consequently, higher adhesion reliability with the adherend member can be realized via the primer treatment layer. As the primer agent, for example, when the adherend member is urethane rubber, an acrylic primer agent, a chlorine primer agent, or the like is suitably used. As the chlorine primer, for example, a composition prepared by dissolving chlorinated isocyanuric acid in a solvent can be used, and the concentration of the chlorinated isocyanuric acid is preferably from 0.5 to 5 wt % in terms of application workability and adhesive property. As the chlorinated isocyanuric acid, chlorinated isocyanuric acid and its salt can be used, and examples thereof include trichloroisocyanuric acid, dichloroisocyanuric acid, sodium dichloroisocyanurate and its hydrate, potassium dichloroisocyanurate, calcium dichloroisocyanurate, magnesium dichloroisocyanurate, and the like.

The cushioning member made of the molded product of the thermoplastic resin composition of the present invention can be used, as another embodiment, in sport equipment, bags, cushioning members for automobiles, building material components, and the like by bonding with an adhesive directly or via a primer treatment layer.

Furthermore, in the cushioning member made of the molded product of the thermoplastic resin composition of the present invention, in order to further improve the ozone resistance, a wax layer or a surface coating layer may be formed on the surface portion of the molded product (cushioning member) exposed to air and light, or surface treatment by irradiation with energy rays reaching a predetermined depth region near the surface of the surface portion may be performed to form a surface layer.

The wax layer for improving the ozone resistance can be formed by applying a wax component to the surface of a molded product (cushioning member). Examples of the wax component include petroleum waxes, natural waxes, and the like, and synthetic waxes obtained by refining or chemically processing multiple waxes also can be used. These waxes may be used alone or in combination of two or more. Examples of the petroleum wax include paraffin wax, microcrystalline wax, and the like, and a petroleum wax that is a mixture of hydrocarbons having about 20 to 80 carbon atoms is preferable, and paraffin wax is further preferable. The natural wax is not particularly limited as long as it is a wax derived from non-petroleum resources, and examples thereof include vegetable waxes such as candelilla wax, carnauba wax, wood wax, rice wax, and jojoba wax; animal waxes such as beeswax, lanolin, and spermaceti wax; mineral waxes such as ozokerite, ceresin, and petrolactam; and refined products thereof. In addition, the wax layer may be formed by adding a wax component to the thermoplastic resin composition within a range not preventing the adhesive property of the molded product (cushioning member) of the thermoplastic resin composition and allowing the wax component to gradually ooze out to the surface of the molded product (cushioning member) to spread a thin wax coating film. The mixing ratio of the wax when added to the thermoplastic resin composition is preferably within a range from 0.1 to 5 parts by weight based on 100 parts by wight of the thermoplastic resin composition from the viewpoint of the balance between the ozone resistance and the adhesive property.

The surface coating layer for improving the ozone resistance can be formed by a known method such as that a resin composition having ozone resistance is applied to the surface of a molded product (cushioning member). The resin composition having ozone resistance is not particularly limited as long as it has excellent adhesion with the surface of a molded product of the thermoplastic resin composition, but when the surface of the molded product is visible as a design, the resin composition preferably has optical transparency.

Furthermore, the surface treatment by energy ray irradiation for improving the ozone resistance crosslinks double bonds of the butadiene block with energy rays in a predetermined depth region near the surface of the surface portion of the molded product of the thermoplastic resin composition and thereby decreases the content of double bonds. Accordingly, a treated surface layer having excellent ozone resistance is formed. As the energy rays, radioactive rays, electron rays, and the like can be applied. The conditions of the energy ray irradiation can be appropriately set depending on the required ozone resistance.

The cushioning member made of the molded product of the thermoplastic resin composition of the present invention may further have a decorative layer formed on its surface. When the above-described surface coating layer or wax layer is formed, the decorative layer is formed between these surface coating layers and the molded product. The decorative layer can be formed by a known method such as application and printing using conventional paints or inks. The thermoplastic resin composition of the present invention has excellent adhesion with paints, inks, or the like and therefore has an effect of facilitating the formation of a beautiful decorative layer.

### EXAMPLES

The present invention will now be described in detail using Examples. The methods for evaluating the physical properties such as an adhesive property, weather resistance, and transparency of thermoplastic resin compositions in the following Examples and Comparative Examples as follows.

### (1) Adhesive Property 1: Creep Test (Flow Deformation)

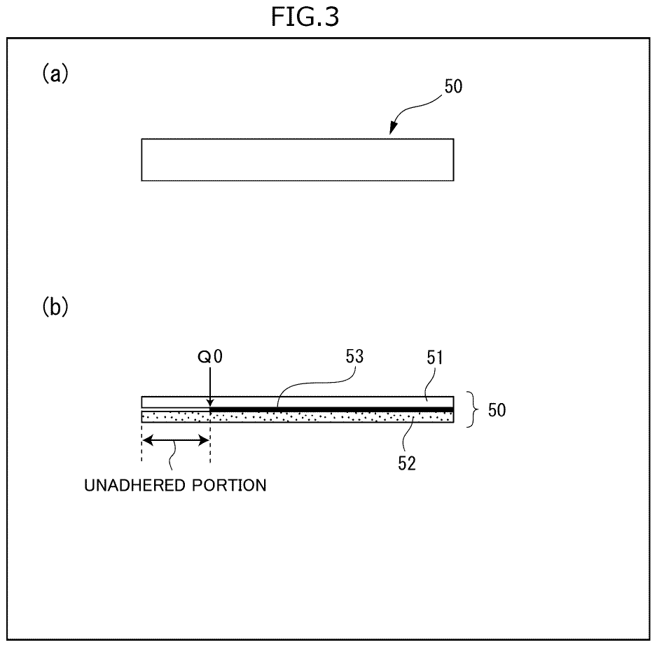

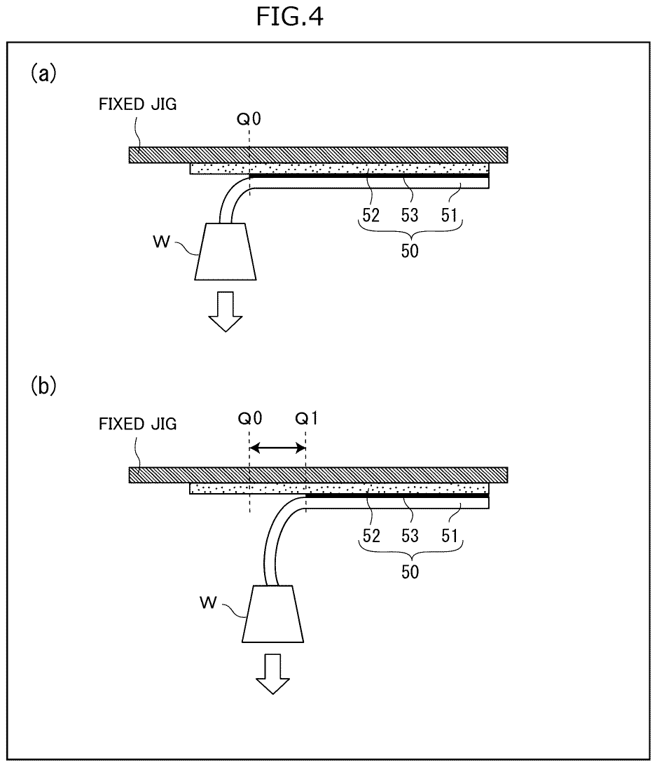

Specific creep test method will be described using FIGS. 3 and 4. FIG. 3 schematically shows the configuration of a sample piece 50, and FIG. 4 illustrates a creep test method of a sample piece. The sample piece 50 shown in FIG. 3 was produced as follows. The molded product of each of the thermoplastic resin compositions in Examples and Comparative Examples was formed into a strip shape (width 20 mm×length 60 mm×thickness 3 mm) to make a test piece 51. A urethane piece 52 (Kuramiron U2195, manufactured by Kuraray Co., Ltd.) produced into a strip shape the same as the test piece 51 (width 20 mm×length 60 mm×thickness 3 mm) was bonded to the test piece 51 with an adhesive 53 to obtain a sample piece 50. More specifically, the surface of the test piece 51 was wiped with Kimwipe (registered trade mark) immersed with ethanol, the surface of the urethane piece 52 was wiped with Kimwipe (registered trade mark) immersed with acetone, and they were then dried at 60° C. for 5 minutes. An adhering primer (a dissolved mixture of P-66 (thinner) and P-66 (grain shape), which are products of No-tape industrial Co., Ltd., in a mixing ratio of 100:2 was used) was applied to one surface of the test piece 51 and was dried at 60° C. for 5 minutes. A mixture of an adhesive 1 (GE6602, a product manufactured by Daito Jushi K.K.,) and an adhesive 2 (GE366S, a product manufactured by Daito Jushi K.K.) in a ratio of adhesive 1:adhesive 2=100:5 was applied onto the adhering primer as an adhesive and was dried at 60° C. for 5 minutes. The same adhesive was further applied thereon and was dried at 60° C. for 5 minutes. In addition, a mixture of an adhesive 3 (812TF, manufactured by Henkel AG & Co.) and an adhesive 4 (Desmodur RFE, manufactured by Bayer AG) in a ratio of adhesive 3:adhesive 4=100:5 was applied onto one surface of the urethane piece 52 as an adhesive and was dried at 60° C. for 5 minutes. The same adhesive was further applied thereon and was dried at 60° C. for 5 minutes. After drying of the adhesives applied to the test piece 51 and the urethane piece 52, the test piece 51 and the urethane piece 52 were quickly bonded to each other. The bonded product was placed with the test piece 51 side facing up and clamped by applying a power of 2 to 3 kgf/cm2 with a hand roller to obtain a sample piece 50. Here, in the bonding the test piece 51 and the urethane piece 52 by the adhesive 53, as shown in FIG. 3(b), at one end in the longitudinal direction, a portion extending 15 mm from the end toward the other end in the longitudinal direction was left as an unadhered portion. This sample piece 50 was cured at 40° C. for 2 hours or more and was then used for a creep test. In the test, if an adhesive sump or the like exists at the end Q0 of the adhered portion of the sample piece 50, since the apparent strength increases, a cut of about 1 mm from the end Q0 of the adhered portion of the sample piece 50 shown in FIG. 3(b) was formed along the adhesive layer on the adhered portion side with a utility knife to form a notch, and the test was then performed. As shown in FIG. 4(a), the sample piece 50 was fixed horizontally on a jig with the urethane piece 52 side facing up, a weight w of 200 g was fixed to the end of the test piece 51 on the unadhered portion side with plastic tape, and the sample piece 50 in the state of being applied with the tensile load in the direction of gravity was left to stand in a hot wind oven of 40° C. (manufactured by Tokyo Rikakikai Co., Ltd., Model No.: WFO-520W) for 24 hours. After 24 hours, as shown FIG. 4(b), the distance from the position Q0 of the end of the adhered portion before the test to the position Q1 of the end of the adhered portion formed due to peeling by creep after the test (distance between Q0 and Q1) was measured.

In the evaluation of the adhesive property by the creep test, a measured value of the distance at which peeling occurred (the length between Q0 and Q1) was evaluated as follows: a measured value of 0 mm (no peeling) as excellent, “∘”, a measured value of 1 mm or less (slight peeling) as fair, “Δ”, and a measured value of greater than 1 mm (peeling) as poor, “X”.

### (2) Adhesive Property 2: Peel Strength

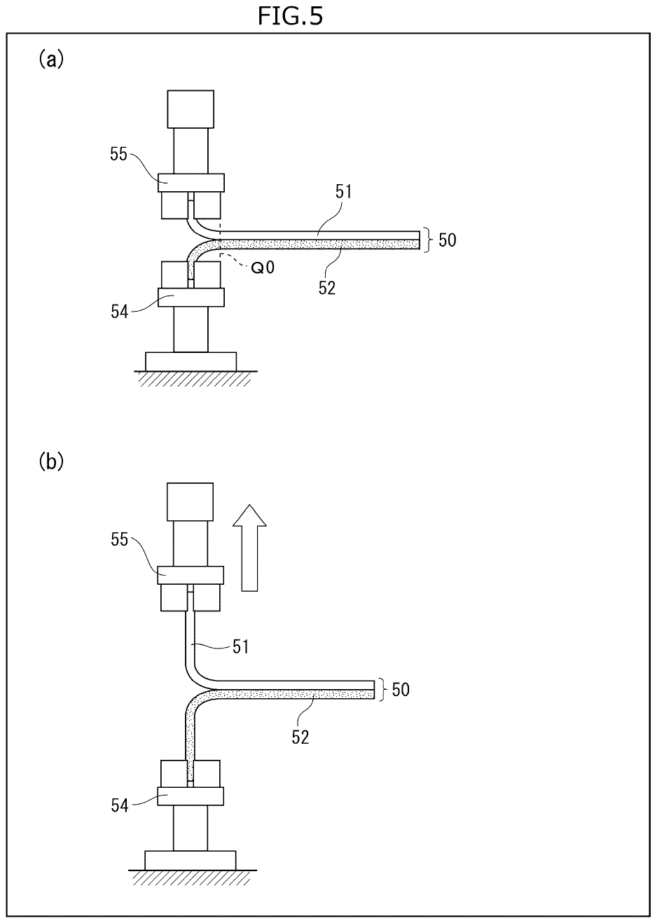

The peel strength of each test piece was measured in accordance with JIS K6854-3. The sample piece was produced in the same way as the sample piece 50 in the above described creep test. This sample piece 50 was cured at 40° C. for 2 hours or more and was then used for the peel strength test. In the test, if an adhesive sump or the like exists at the end Q0 of the adhered portion of the sample piece 50, since the apparent strength increases, as in the creep test, a cut of about 1 mm from the end Q0 of the adhered portion of the sample piece 50 shown in FIG. 3(b) was formed along the adhesive layer on the adhered portion side with a utility knife to form a notch, and the test was then performed. As shown in FIGS. 5(a) and 5(b), the test piece 51 and the urethane piece 52 of the sample piece 50 were peeled with a tensile tester (Autograph (registered trade mark) manufactured by Shimadzu Corporation, AT-100N) to measure the peel strength. In FIG. 5, 54 indicates the fixed side tensile jig, and 55 indicates the movable side tensile jig. The load cell was 1 kN (100 kgf), the test speed was 50 mm/min, and the initial distance between the fixed side tensile jig 54 and the mobile side tensile jig 55 was 20 mm (in FIGS. 5(a) and 5(b), the adhesive 53 constituting the sample piece 50 was omitted).

The peeling state (peel mode) of the interface of the molded product in each test piece 51 after the peel strength measurement was evaluated as follows. The peeling surfaces of each sample piece 50 on the urethane piece 52 side and the test piece 51 side were analyzed by attenuated total reflection method (ATR method) in a wavelength range from 380 to 4,000 cm-1 using an FT-IR apparatus (infrared microscope system Spotlight 200, manufactured by PerkinElmer, Inc.). When a spectrum of SBS, which is the structural component of a molded product of each test piece 51, was not detected in the peeling surface on the test piece 51 side and the peeling surface on the urethane piece 52 side by the analysis, it was defined as “interfacial peeling”. In contrast, the result not corresponding to this “interfacial peeling” indicates fracture mainly within the molded product, and when a spectrum of the SBS was detected in both the peeling surface on the test piece 51 side and the peeling surface on the urethane piece 52 side, it was defined as “molded product fracture”. Here, a spectrum of SBS was obtained by measuring the surface of the molded product constituting each test piece 51 by FT-IR, and the material was identified by comparing the spectra obtained by measuring the peeling surfaces of the sample piece 50 on the urethane piece 52 side and on the test piece 51 side and the respective characteristic absorption bands of the spectrum of SBS to determine the presence or absence of SBS. The identification method of a spectrum was performed in accordance with JIS K6230.

In the evaluation of the adhesive property according to peel strength, regarding test pieces with material fracture inside the molded product, a measured value of 4 kgf/20 mm or more was evaluated as excellent, “∘”, and a measured value of less than 4 kgf/20 mm was evaluated as poor, “X”. A test piece with interfacial peeling was evaluated as poor, “X” regardless of the measured value.

### (3) Ozone Resistance

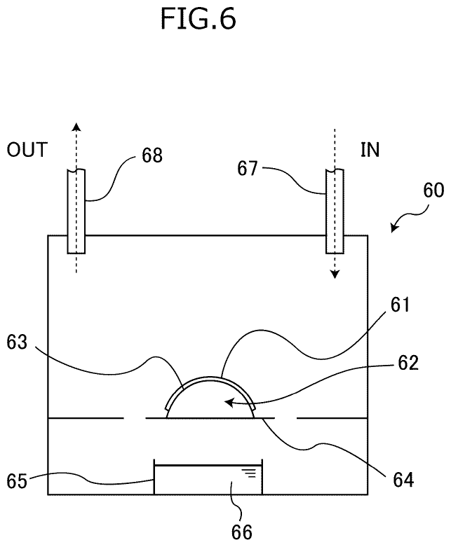

An ozone exposure test method for evaluating ozone resistance will be specifically described using FIG. 6. The molded product of each of the thermoplastic resin compositions of Examples and Comparative Examples was formed into a strip shape (width 20 mm×length 60 mm×thickness 3 mm) to make a test piece 61. The test piece 61 was attached to the curved surface 63 (radius: 40 mm) of a half cylindrical shaped fixed jig 62, and a warpage load was applied to the test piece 61. The fixed jig 62 was fixed on the installation table 64 of a box-shaped test chamber 60 such that the distance from the test piece 61 to the ceiling of the test chamber 60 was 210 mm. In the test chamber 60, a water tank 65 containing water 66 was disposed under the installation table 64. An inlet pipe 67 and a discharge pipe 68 were provided at the top of the test chamber 60, ozone gas generated by an ozone gas generator (ED-OG-7TC, manufactured by EcoDesign, Inc.) was introduced into the test chamber 60 from the inlet pipe 67, the gas in the test chamber 60 was extracted from the discharge pipe 68, and the ozone gas concentration contained in the gas in the test chamber 60 was measured with an ozone gas concentration meter (OZM-7000G2, manufactured by EcoDesign, Inc.). The ozone exposure test was performed by perfusing the test chamber 60 with ozone gas such that the concentration of the ozone gas in the test chamber 60 was 0.5 ppm, disposing the test piece 61 in the test chamber 60 for 16 hours or more, and shooting video of changes in appearance of the test piece 61. The shot video was verified to determine the time at which a crack due to ozone exposure was observed in the test piece 61. The ozone gas concentration of 0.5 ppm in the test chamber 60 in this test corresponds to 100 times of the ozone gas concentration in the atmosphere.

In the evaluation of ozone resistance in the ozone exposure test, when the time at which a crack due to ozone exposure was observed in a test piece 61 was longer than 16 hours (16<) from the start of the test was evaluated as excellent, “∘”, and the time was 16 hours or less was evaluated as poor, “X”.

### (4) Light Resistance

Each of the thermoplastic resin compositions shown in Examples and Comparative Examples was formed into an angle shape (Dumbbell No. 3, thickness: 3 mm) not having a cut to produce each test piece. Three sheets of each test piece were suspended in the chamber of a light resistance tester (Q-SUN Xe-3 xenon arc tester, manufactured by Q-LAB Corporation) by holding one end of the long side of the test piece, and in this state, the test piece was irradiated with xenon arc lamp light (wavelength: 340 nm) under the conditions of a chamber temperature of 40° C., an irradiation dose of 0.35 W/m2, and an irradiation time of 60 hours. The states of each test piece before and after the test were observed visually and by touch, and the presence or absence of the occurrence of discoloring such as yellowing and oil bleeding was verified.

In the evaluation of the light resistance, a test piece on which no “discoloring such as yellowing” or “bleeding” was observed and there was no change in appearance before and after the test was rated as “Δ”, a test piece on which only either “discoloring such as yellowing” or “bleeding” was observed was rated as “B”, and a test piece on which both “discoloring such as yellowing” and “bleeding” were observed was rated as “C”. When all test pieces were rated as “Δ”, the thermoplastic resin composition was evaluated as excellent, “⊚”; when a test piece rated as “B” was included without including a test piece rated as “C”, the composition was evaluated as good, “∘”; and when a test piece rated as “C” was included, the composition was evaluated as poor, “X”.

### (5) Wet Heat Resistance

Each of the thermoplastic resin compositions of shown in Examples and Comparative Examples was formed into 10 sheets of test pieces with an angle shape (Dumbbell B type) not having a cut in accordance with JIS K6252-1 B method, and 5 sheets of the test pieces were exposed to a wet heat environment of a humidity of 95% and a temperature of 80° C. for 4 weeks, and the remaining 5 sheets of the test pieces were stored under a room temperature environment for 4 weeks. After drying at 40° C. for 1 day, the maximum load value F [N] at which break occurred when the tensile speed was 500 mm/min was measured with a tensile tester (Autograph (registered trade mark), AT-100N, manufactured by Shimadzu Corporation), and was divided by the thickness t [m] of the test piece to calculate the tensile break strength (MPa). The average of two values on both sides of the medium of the tensile break strength of the 5 sheets of the test pieces was defined as the tensile break strength (MPa).

The evaluation of the wet heat resistance by tensile break strength evaluates the degree of degradation by wet heat exposure of the molded product of a thermoplastic resin composition. The rate of change in the tensile break strength by wet heat exposure was determined by an expression: “rate of change (%)=(absolute value of a value obtained by subtracting the measured value of tensile break strength of a test piece after wet heat environment storage from the measured value of tensile break strength of the test piece after room temperature storage)/(the measured value of tensile break strength of the test piece after room temperature storage)”. When this rate of change was 10% or less, the test piece was evaluated as excellent, “⊚”; when the rate of change was greater than 10% and 20% or less, the test piece was evaluated as good, “∘”; and when the rate of change was greater than 20%, the test piece was evaluated as poor, “X”.

### (6) Haze Value (Transparency)

The haze of each test piece was measured in accordance with JIS K7136: 2000 using a haze meter (Spectral Haze Meter SH7000, manufactured by Nippon Denshoku Industries Co., Ltd.). Test pieces were produced by forming the molded product of each of the thermoplastic resin compositions of Examples and Comparative Examples into a sheet-like shape (length 50 mm×width 50 mm×thickness 3 mm). When the haze value was 15% or less, the test piece was evaluated as good, “∘”; and when the haze value was greater than 15%, the test piece was evaluated as poor, “X”. Even when the haze value was 15% or less, a test piece including air bubbles was evaluated as poor, “X”.

### (7) Hardness (Asker C)

The hardness of each test piece was measured in accordance with JIS K6253 using Asker C Durometer (SRIS 0101 standard). The molded product of each of the thermoplastic resin compositions of Examples and Comparative Examples was formed into a shape of length of 60 mm×width of 60 mm×thickness of 3 mm, and 4 sheets thereof were stacked in the thickness direction to produce each test piece with a thickness of 12 mm. An Asker C of 30 to 50 was rated as excellent, “∘”, an Asker C of 25 to less than 30 or of greater than 50 to 60 was rated as fair, “Δ”, and an Asker C of less than 25 or of greater than 60 was rated as poor, “X”.

### (8) MFR: Melt Mass-Flow Rate (Flowability)

The melt mass-flow rate of each of the thermoplastic resin compositions was measured in accordance with JIS K7210-1B method at a temperature of 190° C. and a load of 2.16 kg.

The specifications of the structural components of the thermoplastic resin compositions prepared in the following Examples and Comparative Examples are shown in Tables 1 and 2. Among the structural components, in each of the components A11 to A13 and A21 to A23, the butadiene block in the block copolymer constituting the thermoplastic styrenic elastomer (A) was not hydrogenated, but in the component A14 (SBBS), the butadiene block in the block copolymer was partially hydrogenated. The molecular weight of SBS of the component A21 constituting the thermoplastic styrenic elastomer (A) is a measured value. The component A23 includes 31% of oil in addition to component (A) (SBS and SB). In addition, in the softener (B), the molecular weight of naphthene of component B3 is a measured value.

The butadiene content rate and the styrene content rate in each component shown in Table 1 were measured by 1H-NMR method (absolute method) in accordance with JIS K 6239-1:2017 Styrene-butadiene rubber (SBR)—Determination of the microstructure of solution-polymerized SBR—Part 1: 1H-NMR and IR with cast-film method using deuterated chloroform as the measurement solvent at a measurement concentration of 10 mg/0.7 mL. The measurement apparatus used was a nuclear magnetic resonance spectrometry (NMR) apparatus AVANCE NEO 700 manufactured by Bruker.

TABLE 1

| | | | | SBS(A1) | SBBS(A1) | SB(A2) | Butadiene |
|---|---|---|---|---|---|---|---|
| | | | | containing | containing | containing | containing |
| | | Component | | rate | rate | rate | rate |
| Material component | | No. | Component | (mass %) | (mass %) | (mass %) | (mass %) |
| Thermoplastic | Triblock | A11 | SBS | 100% | — | — | 60% |
| styrenic | copolymer | A12 | SBS | 100% | — | — | 57% |
| elastomer (A) | only (A1) | A13 | SBS | 100% | — | — | 76% |
| | | A14 | SBBS (partially | — | 100% | — | 27% |
| | | | hydrogenated | | | | |
| | | | SBS) | | | | |
| | Mixture of | A21 | SBS + SB | 84% | — | 16% | 70% |
| | triblock | A22 | SBS + SB | 12% | — | 78% | 67% |
| | copolymer | A23 | SBS + SB + | 53% | — | 16% | 68% |
| | and | | oil (31%) | | | | |
| | diblock | | | | | | |
| | copolymer | | | | | | |
| | (A1) + (A2) | | | | | | |

| | | | Styrene | | |
|---|---|---|---|---|---|
| | | | containing | | |
| | | Component | rate | Molecular | Product name and |
| Material component | | No. | (mass %) | weight | manufacturer |
| Thermoplastic | Triblock | A11 | 40% | 105,000 | D1155 |
| styrenic | copolymer | | | | Kraton Polymers |
| elastomer (A) | only (A1) | | | | Japan Ltd. |
| | | A12 | 43% | 130,000 | DX408 |
| | | | | | Kraton Polymers |
| | | | | | Japan Ltd. |
| | | A13 | 24% | 150,000 | DX405 |
| | | | | | Kraton Polymers |
| | | | | | Japan Ltd. |
| | | A14 | 47% | 89,000 | P5051 |
| | | | | | Asahi Kasei Corp. |
| | Mixture of | A21 | 30% | 140,000 | D1101 |
| | triblock | | | | Kraton Polymers |
| | copolymer | | | | Japan Ltd. |
| | and | A22 | 33% | 200,000 | D1118 |
| | diblock | | | | Kraton Polymers |
| | copolymer | | | | Japan Ltd. |
| | (A1) + (A2) | A23 | 32% | 350,000 | DX423 |
| | | | | | Kraton Polymers |
| | | | | | Japan Ltd. |

TABLE 2

| | Component | | Molecular | |
|---|---|---|---|---|
| Material | No. | Component | weight | Product name and manufacturer |
| Softener | B1 | Parafine oil | 400 | Daiana Process Oil PW32 |
| (B) | | | | Idemitsu Kosan Co., Ltd. |
| | B2 | Parafine oil | 700 | Daiana Process Oil PW90 |
| | | | | Idemitsu Kosan Co., Ltd. |
| | B3 | Naphtene | 300 | Daiana Fresia (registered trade |
| | | | | mark) N-28 Idemitsu Kosan Co., Ltd. |
| Antioxidant | C1 | Sulfide base | | Irganox (registered trade mark) |
| (C) | | | | 1726 BASF Japan Ltd. |
| | C2 | Hindered phenol | | SUMILIZER (registered trade mark) |
| | | base | | GS (F) Sumitomo Chemical Co., Ltd. |
| | C3 | Phosphite base | | ADK STAB (registered trade mark) |
| | | | | HP-10 Adeka Corp. |
| Photo- | D1 | Benzotriazole | | Tinuvin(registered trade mark) 571 |
| stabilizer | | base | | BASF Japan Ltd. |
| (D) | D2 | Hindered amine | | Tinuvin(registered trade mark) 765 |
| | | base | | BASF Japan Ltd. |

### Example 1

A thermoplastic resin composition of the present Example was prepared by the following procedure, and various physical properties and effects were evaluated by the above-described tests. Table 3 shows the mixing ratios of the structural components of thermoplastic styrenic elastomers (A) in the present Example and each of Examples and Comparative Examples described later. As a thermoplastic styrenic elastomer (A), 27 parts by mass of an SBS (styrene-butylene-styrene triblock copolymer) (A11) in a butadiene block content of 60 mass % and 28 parts by mass of a mixture (A21) of an SBS and an SB (styrene-butadiene diblock copolymer) in a total butadiene block content of 70 mass % were separately weighed using the structural components shown in Table 1. Subsequently, using the structural components shown in Table 2, 45 parts by mass of a softener (B) being paraffin oil (B1) with a molecular weight of 400, 0.63 parts by mass of an antioxidant (C) being a mixture of a sulfide antioxidant (C1), a hindered phenolic antioxidant (C2), and a phosphite antioxidant (C3) mixed in a mixing ratio of C1:C2:C3=26.7:26.7:46.6 by the weight ratio, and 0.5 parts by mass of a photostabilizer (D) being a mixture of a benzotriazole photostabilizer (D1) and a hindered amine photostabilizer (D2) mixed in a mixing ratio of D1:D2=1:1 by the weight ratio were separately prepared. The block copolymers were respectively mixed with paraffin oil at room temperature, the mixtures were then dry-mixed with the antioxidant (C) and the photostabilizer (D) by manual stirring, and the mixtures were heated at 100° C. for 12 hours so that the paraffin oil was absorbed and dispersed in the thermoplastic styrenic elastomer (A). The mixtures were kneaded with a batch type twin-screw kneader (TD3-10MDX model, manufactured by Toshin Co., Ltd.) at 130° C. to 170° C. at a rotation speed of 40 rpm for 15 minutes to obtain a thermoplastic resin composition of Example 1. This composition was injection molded at 170° C. to 190° C. or press molded at 130° C. to 150° C. to obtain a sheet-like molded product. The molded product was cut into a predetermined test piece shape to obtain a molded product with a predetermined test piece shape to be used in the above-described various evaluation tests.

TABLE 3

| | Component No. | | | | | | | |
|---|---|---|---|---|---|---|---|---|
| | A11 | A12 | A13 | A14 | A21 | A22 | A23 | |
| | Butadiene containing rate | | | | | | | Component (A) |
| | 60% | 57% | 76% | 27% | 70% | 67% | 68% | in total |
| | (part by mass) | (part by mass) | (part by mass) | (part by mass) | (part by mass) | (part by mass) | (part by mass) | (part by mass) |
| Example 1 | 27 | — | — | — | 28 | — | — | 55 |
| Example 2 | 44 | — | — | — | 11 | — | — | 55 |
| Example 3 | 11 | — | — | — | 44 | — | — | 55 |
| Example 4 | — | 28.6 | — | — | 29.8 | — | — | 58.4 |
| Example 5 | 22.1 | — | — | — | 23 | — | — | 45.1 |
| Example 6 | — | 30 | 25 | — | — | — | — | 55 |
| Example 7 | 17.5 | — | 9.5 | — | 23.9 | 4.1 | — | 55 |
| Example 8 | 27 | — | — | — | 28 | — | — | 55 |
| Example 9 | 27 | — | — | — | 28 | — | — | 55 |
| Example 10 | 27 | — | — | — | 28 | — | — | 55 |
| Example 11 | 27 | — | — | — | 28 | — | — | 55 |
| Example 12 | 27 | — | — | — | 28 | — | — | 55 |
| Example 13 | — | — | — | 5 | 40 | — | — | 45 |
| Example 14 | — | — | — | 10 | 45 | — | — | 55 |
| Example 15 | — | — | — | 10 | 35 | — | — | 45 |
| Example 16 | — | — | — | 11.5 | 33.5 | — | — | 45 |
| Comparative | 28 | 27 | — | — | — | — | — | 55 |
| Example 1 | | | | | | | | |
| Comparative | 13.1 | — | 13.9 | — | 28 | — | — | 55 |
| Example 2 | | | | | | | | |
| Comparative | 23.6 | — | — | — | 35.4 | — | — | 59 |
| Example 3 | | | | | | | | |
| Comparative | 19.6 | — | — | — | 20.4 | — | — | 40 |
| Example 4 | | | | | | | | |
| Comparative | — | — | — | — | 21 | — | 46 | 52.74 |
| Example 5 | | | | | | | (31.74)* | |

*The number in parentheses is the value as the component (A) excluding oil component contained in A23

The obtained thermoplastic resin compositions and molded products thereof were subjected to the above-described various evaluation tests to evaluate the various physical properties. The results in Example 1 are shown in Table 4.

### Examples 2 to 16

Thermoplastic resin compositions of other Examples were obtained as in Example 1 except that the structural components and mixing ratios of the thermoplastic styrenic elastomer (A) were changed as shown in Table 3 and that the structural component and mixing ratio of the softener (B) and the mixing ratios of the antioxidant (C) and the photostabilizer (D) were changed as shown in Tables 4 to 6. As in Example 1, the obtained thermoplastic resin compositions and molded products thereof were subjected to the above-described various evaluation tests to evaluate the various physical properties. The results in Examples 2 to 6 are shown in Table 4, the results in Examples 7 to 12 are shown in Table 5, and the results in Examples 13 to 16 are shown in Table 6. The results of the wet heat resistance rest of the molded products of the thermoplastic resin compositions obtained in Examples 9 and 10 are shown in Table 8.

### Comparative Examples 1 to 4

Thermoplastic resin compositions of Comparative Examples were obtained as in Example 1 except that the structural components and mixing ratios of the thermoplastic styrenic elastomer (A) were changed as shown in Table 3 and that the mixing ratios of the softener (B), the antioxidant (C), and the photostabilizer (D) were respectively changed as shown in Table 7. As in Example 1, the obtained thermoplastic resin compositions and molded products thereof were subjected to the above-described various evaluation tests to evaluate various physical properties. The results in Comparative Examples 1 to 4 are shown in Table 7.

TABLE 4

| | | | | Example 1 | Example 2 | Example 3 | Example 4 | Example 5 | Example 6 |
|---|---|---|---|---|---|---|---|---|---|
| Composition | Thermoplastic | Butadiene | mass % | 65.0 | 62.0 | 67.9 | 63.6 | 65.0 | 65.6 |
| | styrenic | total content | | | | | | | |
| | elastomer (A) | Styrene | mass % | 35.0 | 38.0 | 32.1 | 36.4 | 35.0 | 34.4 |
| | | total content | | | | | | | |
| | | SBS (A1) | mass % | 91.9 | 96.8 | 87.2 | 91.8 | 91.8 | 100 |
| | | mixing ratio | | | | | | | |
| | | SB (A2) | mass % | 8.1 | 3.2 | 12.8 | 8.2 | 8.2 | 0 |
| | | mixing ratio | | | | | | | |
| | | (A2)/(A1) | mass ratio | 0.09 | 0.03 | 0.15 | 0.09 | 0.09 | 0.00 |
| | | (A) | part by mass | 55.0 | 55.0 | 55.0 | 58.4 | 45.0 | 55.0 |

| | | | | | | | | |
|---|---|---|---|---|---|---|---|---|
| | Softener (B) | Component | B1 | B1 | B1 | B1 | B1 | B1 |
| | | Molecular | 400 | 400 | 400 | 400 | 400 | 400 |
| | | weight | | | | | | |
| | | part by mass | 45.0 | 45.0 | 45.0 | 41.6 | 55.0 | 45.0 |
| | (B)/(A + B) | mass ratio | 0.450 | 0.450 | 0.450 | 0.416 | 0.550 | 0.450 |
| | Antioxidant (C) | part by mass | 0.63 | 0.63 | 0.63 | 0.67 | 0.5 | 0.63 |
| | Photostabilizer (D) | part by mass | 0.5 | 0.5 | 0.5 | 0.53 | 0.5 | 0.5 |
| Evaluation | Adhesiveness 1: creep test | mm | 0 | 0 | 0 | 0 | 0 | 0 |
| | | Judgement | ◯ | ◯ | ◯ | ◯ | ◯ | ◯ |
| | Adhesiveness 2: peel strength | kgf/20 mm | 5.2 | 4.6 | 8.5 | 10.4 | 4.0 | 4.0 |
| | | Peel mode | Molded | Molded | Molded | Molded | Molded | Molded |
| | | | product | product | product | product | product | product |
| | | | fracture | fracture | fracture | fracture | fracture | fracture |
| | | Judgement | ◯ | ◯ | ◯ | ◯ | ◯ | ◯ |
| | Ozone resistance | hr | 16< | 16< | 16< | 16< | 16< | 16< |
| | | Judgement | ◯ | ◯ | ◯ | ◯ | ◯ | ◯ |
| | Light resistance test | Decoloring | None | None | None | None | None | None |
| | | Bleeding | None | None | None | None | None | None |
| | | Judgement | ⊚ | ⊚ | ⊚ | ⊚ | ⊚ | ⊚ |
| | Tranceparency (haze value) | % | 11.3 | 6.1 | 6.6 | 3.2 | 4.3 | 2.1 |
| | | Judgement | ◯ | ◯ | ◯ | ◯ | ◯ | ◯ |
| | Hardness (Asker C) | HC | 47 | 47 | 46 | 50 | 36 | 45 |
| | | Judgement | ◯ | ◯ | ◯ | ◯ | ◯ | ◯ |
| | Flowability (MFR) | g/10 min | 91 | 283 | 38 | 70 | 389 | 413 |

TABLE 5

| | | | | Example 7 | Example 8 | Example 9 | Example 10 | Example 11 | Example 12 |
|---|---|---|---|---|---|---|---|---|---|
| Composition | Thermoplastic | Butadiene | mass % | 67.6 | 65.0 | 65.0 | 65.0 | 65.0 | 65.0 |
| | styrenic | total content | | | | | | | |
| | elastomer (A) | Styrene | mass % | 32.4 | 35.0 | 35.0 | 35.0 | 35.0 | 35.0 |
| | | total content | | | | | | | |
| | | SBS (A1) | mass % | 83.5 | 91.9 | 91.9 | 91.9 | 91.9 | 91.9 |
| | | mixing ratio | | | | | | | |
| | | SB (A2) | mass % | 16.5 | 8.1 | 8.1 | 8.1 | 8.1 | 8.1 |
| | | mixing ratio | | | | | | | |
| | | (A2)/(A1) | mass ratio | 0.20 | 0.09 | 0.09 | 0.09 | 0.09 | 0.09 |
| | | (A) | part by mass | 55.0 | 55.0 | 55.0 | 55.0 | 55.0 | 55.0 |

| | | | | | | | | |
|---|---|---|---|---|---|---|---|---|
| | Softener (B) | Component | B1 | B1 | B1 | B1 | B3 | B2 |
| | | Molecular | 400 | 400 | 400 | 400 | 300 | 700 |
| | | weight | | | | | | |
| | | part by mass | 45 | 45 | 45 | 45 | 45 | 45 |
| | (B)/(A + B) | mass ratio | 0.450 | 0.450 | 0.450 | 0.450 | 0.450 | 0.450 |
| | Antioxidant (C) | part by mass | 0.63 | 0 | 0.63 | 0 | 0.63 | 0.63 |
| | Photostabilizer (D) | part by mass | 0.5 | 0.5 | 0 | 0 | 0.5 | 0.5 |
| Evaluation | Adhesiveness 1: creep test | mm | 0 | 0 | 0 | 0 | 0 | 0 |
| | | Judgement | ◯ | ◯ | ◯ | ◯ | ◯ | ◯ |
| | Adhesiveness 2: peel strength | kgf/20 mm | 4.5 | 7.7 | 7.5 | 7.7 | 5.0 | 10.4 |
| | | Peel mode | Molded | Molded | Molded | Molded | Molded | Molded |
| | | | product | product | product | product | product | product |
| | | | fracture | fracture | fracture | fracture | fracture | fracture |
| | | Judgement | ◯ | ◯ | ◯ | ◯ | ◯ | ◯ |
| | Ozone resistance | hr | 16< | 16< | 16< | 16< | 16< | 16< |
| | | Judgement | ◯ | ◯ | ◯ | ◯ | ◯ | ◯ |
| | Light resistance test | Decoloring | None | None | Yes | Yes | Yes | None |
| | | Bleeding | None | None | None | None | None | None |
| | | Judgement | ⊚ | ⊚ | ◯ | ◯ | ◯ | ⊚ |
| | Tranceparency (haze value) | % | 7.6 | 6 | 3.5 | 5 | 6 | 5.6 |
| | | Judgement | ◯ | ◯ | ◯ | ◯ | ◯ | ◯ |
| | Hardness (Asker C) | HC | 44 | 46.2 | 46.2 | 46.3 | 55 | 45 |
| | | Judgement | ◯ | ◯ | ◯ | ◯ | Δ | ◯ |
| | Flowability (MFR) | g/10 min | 110 | 94 | 87 | 88 | 177 | 40 |

TABLE 6

| | | | | | Example 13 | Example 14 | Example 15 | Example 16 |
|---|---|---|---|---|---|---|---|---|
| Composition | Thermoplastic | Butadiene total content | | mass % | 65.3 | 62.3 | 60.5 | 59.1 |
| | styrenic | Styrene total content | | mass % | 31.9 | 33.0 | 33.7 | 34.3 |
| | elastomer (A) | (A1) | SBS | mass % | 74.7 | 68.7 | 65.3 | 62.5 |
| | | | mixing ratio | | | | | |
| | | | SBBS (partially | mass % | 11.1 | 18.2 | 22.2 | 25.6 |
| | | | hydrogenated SBS) | | | | | |
| | | | mixing ratio | | | | | |
| | | (A2) | SB | mass % | 14.2 | 13.1 | 12.4 | 11.9 |
| | | | mixing ratio | | | | | |

| | | | | | |
|---|---|---|---|---|---|
| (A2)/(A1) | mass ratio | 0.17 | 0.15 | 0.14 | 0.14 |
| (A) | part by mass | 45.0 | 55.0 | 45.0 | 45.0 |

| | | | | | | |
|---|---|---|---|---|---|---|
| | Softner (B) | Component | B1 | B1 | B1 | B1 |
| | | Molecular | 400 | 400 | 400 | 700 |
| | | weight | | | | |
| | | part by mass | 55 | 45 | 45 | 55 |
| | (B)/(A + B) | mass ratio | 0.550 | 0.450 | 0.500 | 0.550 |
| | Antioxidant (C) | part by mass | 0 | 0 | 0 | 0 |
| | Photostabilizer (D) | part by mass | 0 | 0 | 0 | 0 |
| Evaluation | Adhesiveness 1: creep test | mm | 0.5 | 0 | 0 | 0 |
| | | Judgement | Δ | ◯ | ◯ | ◯ |
| | Adhesiveness 2: peel strength | kgf/20 mm | 4.9 | 7.4 | 6.0 | 4.8 |
| | | Peel mode | molded | molded | molded | molded |
| | | | product | product | product | product |
| | | | fracture | fracture | fracture | fracture |
| | | Judgement | ◯ | ◯ | ◯ | ◯ |
| | Ozone resistance | hr | 16< | 16< | 16< | 16< |
| | | Judgement | ◯ | ◯ | ◯ | ◯ |
| | Light resistance test | Decoloring | None | None | None | None |
| | | Bleeding | Yes | Yes | Yes | Yes |
| | | Judgement | ◯ | ◯ | ◯ | ◯ |
| | Transparency (haze value) | % | 10.8 | 12.0 | 10.2 | 9.4 |
| | | Judgement | ◯ | ◯ | ◯ | ◯ |
| | Hardness (Asker C) | HC | 35 | 48 | 37 | 37 |
| | | Judgement | ◯ | ◯ | ◯ | ◯ |
| | Flowability (MFR) | g/10 min | 123 | 32 | 215 | 278 |

TABLE 7

| | | | | Comparative | Comparative | Comparative | Comparative |
|---|---|---|---|---|---|---|---|
| | | | | Example 1 | Example 2 | Example 3 | Example 4 |
| Composition | Thermoplastic | Butadiene | mass % | 58.5 | 69.1 | 65.9 | 65.0 |
| | styrenic | total content | | | | | |
| | elastomer (A) | Styrene | mass % | 41.5 | 30.9 | 34.1 | 35.0 |
| | | total content | | | | | |
| | | SBS (A1) | mass % | 100 | 91.9 | 90.4 | 91.8 |
| | | mixing ratio | | | | | |
| | | SB (A2) | mass % | 0 | 8.1 | 9.6 | 8.2 |
| | | mixing ratio | | | | | |
| | | (A2)/(A1) | mass ratio | 0.00 | 0.09 | 0.11 | 0.09 |
| | | (A) | part by mass | 55.0 | 55.0 | 59.0 | 40.0 |

| | | | | | | |
|---|---|---|---|---|---|---|
| | Softener (B) | Component | B1 | B1 | B1 | B1 |
| | | Molecular | 400 | 400 | 400 | 400 |
| | | weight | | | | |
| | | part by mass | 45 | 45 | 41 | 60 |
| | (B)/(A + B) | mass ratio | 0.450 | 0.450 | 0.410 | 0.600 |
| | Antioxidant (C) | part by mass | 0.63 | 0.63 | 0.67 | 0.46 |
| | Photostabilizer (D) | part by mass | 0.5 | 0.5 | 0.54 | 0.36 |
| Evaluation | Adhesiveness 1: creep test | mm | 5 | 0 | 0 | 0 |
| | | Judgement | X | ◯ | ◯ | ◯ |
| | Adhesiveness 2: peel strength | kgf/20 mm | 4.0 | 5.9 | 10.1 | 1.6 |
| | | Peel mode | Interfacial | Molded | Molded | Molded |
| | | | peeling | product | product | product |
| | | | | fracture | fracture | fracture |
| | | Judgement | X | ◯ | ◯ | X |
| | Ozone resistance | hr | 16< | 8 | 4 | 16< |
| | | Judgement | ◯ | X | X | ◯ |
| | Lightresistance test | Decoloring | None | None | None | None |
| | | Bleeding | None | None | None | None |
| | | Judgement | ⊚ | ⊚ | ⊚ | ⊚ |
| | Tranceparency (haze value) | % | 3.6 | 4.4 | 6.1 | 10.1 |
| | | Judgement | ◯ | ◯ | ◯ | ◯ |
| | Hardness (Asker C) | HC | 49 | 47 | 54 | 21 |
| | | Judgement | ◯ | ◯ | Δ | X |
| | Flowability (MFR) | g/10 min | 523 | 78 | 40 | 60 |

### Comparative Example 5

A thermoplastic resin composition of Comparative Example 5 was obtained as in Example 1 except that the structural components and the mixing ratio of the thermoplastic styrenic elastomer (A) were changed as shown in Table 3 and that the mixing ratios of the softener (B), the antioxidant (C), and the photostabilizer (D) were changed as shown in Table 8. Since A23 used as the structural component of the thermoplastic styrenic elastomer (A) included 31 mass % of an oil component in addition to SBS and SB, the total amount of the component (A) was calculated excluding the amount of oil components. The obtained molded product of the thermoplastic resin composition was subjected to wet heat resistance and light resistance tests to evaluate various physical properties. The results in Comparative Example 5 and the results in Examples 9 and 10 are shown in Table 8.

TABLE 8

| | | | | | | Comparative |
|---|---|---|---|---|---|---|
| | | | | Example 9 | Example 10 | Example 5 |
| Composition | Thermoplastic | Butadiene | mass % | 65.0 | 65.0 | 68.8 |
| | styrenic | total content | | | | |
| | elastomer (A) | Styrene | mass % | 35.0 | 35.0 | 31.2 |
| | | total content | | | | |
| | | SBS (A1) | mass % | 91.9 | 91.9 | 89.3 |
| | | mixing ratio | | | | |
| | | SB (A2) | mass % | 8.1 | 8.1 | 10.7 |
| | | mixing ratio | | | | |
| | | (A2)/(A1) | mass ratio | 0.09 | 0.09 | 0.12 |
| | | (A) | part by mass | 55.0 | 55.0 | 52.7 |

| | | | | | |
|---|---|---|---|---|---|
| | Softener (B) | Component | B1 | B1 | B1 |
| | | Molecular | 400 | 400 | 400 |
| | | weight | | | |
| | | part by mass | 45 | 45 | 33 |
| | (B)/(A + B) | mass ratio | 0.450 | 0.450 | 0.473 |
| | Antioxidant (C) | part by mass | 0.63 | 0 | 0 |
| | Photostabilizer (D) | part by mass | 0 | 0 | 0 |
| Evaluation | Wet heat resistance | % | 7.2 | 11.5 | 64 |
| | | Judgement | ⊚ | ◯ | X |
| | Light resistance test | Decoloring | Yes | Yes | Yes |
| | | Bleeding | None | None | Yes |
| | | Judgement | ◯ | ◯ | X |

The results in Examples 1 to 16 shown in Tables 4 to 6 and the results in Comparative Examples 1 to 5 shown in Tables 7 and 8 demonstrate that it is possible by the constitution according to the present invention to obtain a thermoplastic resin composition that can form a cushioning member not only having an excellent adhesive property and peel strength but also capable of suppressing peeling due to flow deformation (creep) reproducing severe stress deformation conditions and also having weather resistance.

Specifically, it was demonstrated from the results in Examples 1 to 16 that in the thermoplastic resin composition in which the total content of butadiene with carbon-carbon double bonds of the butadiene block in the thermoplastic styrenic elastomer (A) was within a range from 62.0 to 67.9 mass % and the mixing ratio of the thermoplastic styrenic elastomer (A) and the softener (B), B/(A+B), was within a range from 0.416 to 0.550 by mass ratio, the peel strength was excellent with material fracture of the molded product in the peel test, the flow deformation was also suppressed in the creep test, and the adhesive property with another material, transparency in appearance, flexibility, ozone resistance, and light resistance were excellent. It was demonstrated that in the thermoplastic resin composition in which the total content of the styrene block in the thermoplastic styrenic elastomer (A) was within a range from 31.9 to 38.0 mass %, the peel strength was excellent with material fracture of the molded product in the peel test, the flow deformation was also suppressed in the creep test, and the adhesive property with another material, transparency in appearance, flexibility, ozone resistance, and light resistance were excellent.

In addition, it was demonstrated that in the thermoplastic resin compositions in Examples 1 to 16, when the mixing ratio of the styrene-butadiene-styrene triblock copolymer (A1) and the styrene-butadiene diblock copolymer (A2), (A1):(A2), was within a range of 1:from 0.00 to 0.20, it is possible to obtain a cushioning member in which the peel strength is excellent with material fracture of the molded product in the peel test, the flow deformation is also suppressed in the creep test, and the adhesive property with another material, transparency in appearance, flexibility, ozone resistance, and light resistance are excellent. Furthermore, it was demonstrated that the melt flowability (MFR) of the thermoplastic resin composition can be adjusted within a range allowing ease of handling by adjusting to the ratio, (A1):(A2)=1:within a range from greater than 0 to 0.20. It was also confirmed that even if the softener (B) is a paraffinic oil having a molecular weight of 400 or 700 or naphthenic oil having a molecular weight of 300, the cushioning member has suitable flexibility and good physical properties.

In Examples 1 to 12, only an unhydrogenated styrene-butadiene-styrene triblock copolymer that was not substantially hydrogenated was used as the styrene-butadiene-styrene triblock copolymer (A1), but in Examples 13 to 16, a combination of an unhydrogenated styrene-butadiene-styrene triblock copolymer (unhydrogenated SBS) and a partially hydrogenated styrene-butadiene-styrene triblock copolymer (i.e., SBBS) was used as the styrene-butadiene-styrene triblock copolymer (A1). According to this result, it was demonstrated that in a thermoplastic resin composition of a mixture of the styrene-butadiene-styrene triblock copolymer (A1) and the styrene-butadiene diblock copolymer (A2), even when unhydrogenated SBS and SBBS were used in combination as the styrene-butadiene-styrene triblock copolymer (A1), excellent effects were obtained as in the case of using unhydrogenated SBS only. The thermoplastic resin compositions in Examples 13 to 16 had ozone resistance and light resistance and showed excellent weather resistance even when neither an antioxidant nor a photostabilizer is contained.

By comparing the results of Comparative Example 1 and Example 6 in which the thermoplastic styrenic elastomer (A) was constituted of SBS, it was demonstrated that a thermoplastic resin composition in which the total content of butadiene was 58.5 mass % and the total content of styrene was 41.5 mass % in the thermoplastic styrenic elastomer (A) was inferior in the adhesive property. In contrast, it was demonstrated that a thermoplastic resin composition in which the total content of butadiene was 65.6 mass % and the total content of styrene was 34.4 mass % in the thermoplastic styrenic elastomer (A) had an improved adhesive property.

By comparing the results of Comparative Example 2 and Example 8 in which the thermoplastic styrenic elastomer (A) was constituted of a combination of SBS and SB, it was demonstrated that a thermoplastic resin composition in which the total content of butadiene was 61.9 mass % and the total content of styrene was 30.9 mass % in the thermoplastic styrenic elastomer (A) was inferior in the ozone resistance. In contrast, it was demonstrated that a thermoplastic resin composition in which the total content of butadiene was 65.0 mass % and the total content of styrene was 35.0 mass % in the thermoplastic styrenic elastomer (A) had improved ozone resistance.

It was demonstrated from the results of Comparative Example 3 and Example 4 that a thermoplastic resin composition in which the mixing ratio of the thermoplastic styrenic elastomer (A) and the softener (B), B/(A+B), was 0.410 by mass ratio was inferior in the ozone resistance and that a thermoplastic resin composition in which the ratio, B/(A+B), was 0.416 had sufficient ozone resistance. It was demonstrated from the results of Comparative Example 4 and Example 5 that a thermoplastic resin composition in which the mixing ratio of the thermoplastic styrenic elastomer (A) and the softener (B), B/(A+B), was 0.600 by mass ratio was inferior in the adhesive property and that a thermoplastic resin composition in which the ratio, B/(A+B), was 0.550 had an improved adhesive property.

It was confirmed by the results in Examples 8 to 10 and 13 to 16 that the thermoplastic resin composition according to the present invention has ozone resistance, light resistance, and wet heat resistance and shows excellent weather resistance even when the antioxidant and/or the photostabilizer was not contained.

Furthermore, as obvious from the results of Comparative Example 5 and Example 10 shown in Table 8, in a thermoplastic resin composition in which the total content of butadiene in the thermoplastic styrenic elastomer (A) was 68.8 mass %, the wet heat resistance and the light resistance were insufficient. In contrast, in a thermoplastic resin composition in which the total content of butadiene in the thermoplastic styrenic elastomer (A) was 65.0 mass %, the wet heat resistance and the light resistance were improved.

The present invention is not limited to the above-described embodiments and Examples, and various design modifications that do not deviate from the gist of the invention described in the claims are also included in the technical scope.

### INDUSTRIAL APPLICABILITY

The thermoplastic resin composition of the present invention is used mainly in a cushioning member for shoes, such as a sole and an insole of shoes, and also useful widely in the field of personal products including footwear and bag accessories, such as bag grips and shoulder pads.

### REFERENCE SIGNS LIST

1 shoe
10, 10a cushioning member for footwear
11a molded product
12 primer layer
13 protective coating layer
20 sole member
21 adhered surface of a cushioning member for footwear and a sole member
50 test piece
51 test piece (cushioning member in Examples or Comparative Examples)
52 urethane piece
53 adhesive
54 fixed side tensile jig
55 movable side tensile jig
Q0 end of an adhered portion
Q1 end of an adhered portion after a test
W weight
60 test chamber
61 test piece (cushioning member in Examples or Comparative Examples)
62 fixed jig
63 curved surface
64 installation table
65 water tank
66 water
67 inlet pipe
68 discharge pipe

1. A thermoplastic resin composition comprising:
a thermoplastic styrenic elastomer (A); and
a softener (B), wherein
the thermoplastic styrenic elastomer (A) includes one or more block copolymers, each composed of at least a styrene block and a butadiene block,
in the thermoplastic styrenic elastomer (A), a total content of butadiene with carbon-carbon double bonds of the butadiene block is from 59.0 to 68.5 mass %, and
a mixing ratio of the thermoplastic styrenic elastomer (A) and the softener (B), B/(A+B), is greater than 0.410 and less than 0.600 by mass ratio.

2. The thermoplastic resin composition according to claim 1, wherein in the thermoplastic styrenic elastomer (A), a total content of the styrene block is from 31.5 to 41.0 mass %.

3. The thermoplastic resin composition according to claim 2, wherein a main component of the thermoplastic styrenic elastomer (A) is a styrene-butadiene-styrene triblock copolymer (A1).

4. The thermoplastic resin composition according to claim 3, wherein
the thermoplastic styrenic elastomer (A) includes the styrene-butadiene-styrene triblock copolymer (A1) and a styrene-butadiene diblock copolymer (A2), and
a mixing ratio of the styrene-butadiene-styrene triblock copolymer (A1) and the styrene-butadiene diblock copolymer (A2), (A1):(A2), is 1:greater than 0 and less than 0.3 by mass ratio.

5. The thermoplastic resin composition according to claim 3, wherein the styrene-butadiene-styrene triblock copolymer (A1) includes a combination of an unhydrogenated styrene-butadiene-styrene triblock copolymer and a partially hydrogenated styrene-butadiene-styrene triblock copolymer.

6. The thermoplastic resin composition according to claim 1, wherein the butadiene block in the one or more block copolymers is not substantially hydrogenated.

7. The thermoplastic resin composition according to claim 1, wherein the softener (B) is paraffinic oil or naphthenic oil having a molecular weight of 300 to 1,200.

8. The thermoplastic resin composition according to claim 1, further comprising an antioxidant.

9. The thermoplastic resin composition according to claim 1, further comprising a photostabilizer.

10. The thermoplastic resin composition according to claim 1, wherein a molded product of the thermoplastic resin composition has a hardness of 30 to 50 Asker C (SRIS 0101 standard, 23±2° C.) and a haze value (conforming to JIS K7136: 2000) of 15% or less.

11-13. (canceled)

14. The thermoplastic resin composition according to claim 4, wherein a molded product of the thermoplastic resin composition has a hardness of 30 to 50 Asker C (SRIS 0101 standard, 23±2° C.) and a haze value (conforming to JIS K7136: 2000) of 15% or less.

15. A cushioning member comprising a molded product of the thermoplastic resin composition according to claim 1.

16. The cushioning member according to claim 15, characterized by being for footwear.

17. A composition for a three-dimensional printer, comprising the thermoplastic resin composition according to claim 1.
